(19) United States
(12) Patent Application Publication
(10) Pub. No.: US 2026/0138467 A1
(43) Pub. Date: May 21, 2026

(54) ELECTRIC VEHICLE MOTOR DEACTIVATION FOR BATTERY CHARGING

(71) Applicant: GM GLOBAL TECHNOLOGY OPERATIONS LLC, Detroit, MI (US)

(72) Inventors: Peng Peng, Rochester Hills, MI (US); Lei Hao, Shelby Township, MI (US); Suresh Gopalakrishnan, Troy, MI (US)

(73) Assignee: GM GLOBAL TECHNOLOGY OPERATIONS LLC, Detroit, MI (US)

(21) Appl. No.: 18/954,629

(22) Filed: Nov. 21, 2024

(51) Int. Cl. B60L 50/51

(52) U.S. Cl. CPC B60L 50/51; B60L 2220/54

(57) ABSTRACT

A battery charging system for an electric vehicle including an electric motor having a first stator winding having a variable number of poles, a second stator winding having a first fixed number of poles and a rotor winding having a second fixed number of poles, wherein the first fixed number of poles is not equal to the second fixed number of poles, wherein the variable number of poles is equal to the first fixed number of poles during a charging operation of the battery in response to the alternating current.

### INTRODUCTION

The present disclosure generally relates to automotive electrical systems and electric vehicle battery charging systems, and more particularly relates to a method and apparatus to employ electric motor pole number mismatch to deactivate a motor to eliminate back electromagnetic force (EMF) and torque.

Modern electric vehicles (EVs) offer sustainable and efficient transportation. Powered by electric motors, EVs deliver instant torque, resulting in smooth and responsive acceleration. Electric motors are used in EVs to convert electrical energy from the battery into mechanical energy to turn the wheels. Typically, there are two main types of electric motors used in EVs: induction motors and permanent magnet synchronous motors (PMSMs). Induction motors are the most common type of electric motor used in EVs as they are very efficient, and they can provide a high torque output. PMSMs are often used in high-performance EVs, such as sports cars and racing cars. Modern EVs typically have two electric motors, one for each axle, but some EVs can have a single motor located under the hood or four motors, one for each wheel. Regenerative braking technology further enhances efficiency by capturing kinetic energy during deceleration and converting it into electricity. As battery technology advances, EVs are becoming increasingly practical for everyday use, with longer ranges, faster charging times, and lower maintenance costs. The expanding charging infrastructure provides convenience and peace of mind, making EV ownership more accessible than ever before.

Electric vehicle on-board battery charging equipment (OBC) is a component of the electric vehicle charging process which converts alternating current (AC) power from the grid into direct current (DC) power that can be directly absorbed by the vehicle's battery. The OBC regulates the charging rate, ensuring optimal battery health and longevity. OBCs are designed to be highly efficient, minimizing energy loss during the charging process. This not only reduces the overall charging time but also contributes to lower energy consumption and a smaller environmental footprint. It is desirable to continue to improve the OBC to improve EV efficiency and convenience. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle propulsion methods and systems and related electrical systems for charging electric vehicle batteries, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for providing an exemplary electric vehicle charging system with a variable pole stator winding in an electric motor.

In accordance with an aspect of the present disclosure, an electric vehicle drive system including a battery, wherein the battery is charged in response to a direct current (DC) current, an input for receiving an alternating current (AC) current from an external power source, a sensor for detecting a parameter of the AC current, an electric motor having a first stator winding having a variable number of poles, a second stator winding having a first fixed number of poles and a rotor having a second fixed number of poles, wherein the variable number of poles selects a pole number that is equal to the first and second fixed number of poles during a battery charging operation, an inverter for converting the AC current received from the first stator winding to the DC current in response to an inverter control signal, and an inverter controller for controlling the inverter in response to the parameter of the AC current such that the battery is charged in response to the DC current.

In accordance with another aspect of the present disclosure, wherein the variable number of poles is equal to the second fixed number of poles during a propulsion mode of the electric vehicle.

In accordance with another aspect of the present disclosure, wherein during a propulsion mode of the electric vehicle the variable number of poles is not equal to the second fixed number of poles such that a voltage is not induced in the winding.

In accordance with another aspect of the present disclosure, wherein the two windings may have different number of turns.

In accordance with another aspect of the present disclosure, wherein a pole number mismatch between the two windings caused the electric motor to lose synchronization, resulting in a elimination of torque or induced voltage of the electric motor.

In accordance with another aspect of the present disclosure, further including a transformer for transforming the DC current to a DC voltage having an amplitude suitable for charging the battery.

In accordance with another aspect of the present disclosure, wherein the sensor is configured to detect a phase of the AC current and wherein the inverter controller is configured to control the inverter in response to the phase of the AC current.

In accordance with another aspect of the present disclosure, wherein the AC current is a three phase current and wherein the parameter is a phase difference between a first phase and a second phase of the three phase current.

In accordance with another aspect of the present disclosure, wherein the input is electrically coupled to the electric motor by a first switch and to a diode pair return path by a second switch in a charging mode.

In accordance with another aspect of the present disclosure, a method of controlling a electric drive system including charging a battery in response to a DC current, receiving, at a charging port, an AC current from an external power source, detecting, by a sensor, a parameter of the AC current, coupling the AC current to a second stator winding of an electric motor having a first stator winding having a variable number of poles, the second stator winding having a first fixed number of poles and a rotor winding having a second fixed number of poles, such that the AC current is coupled from the second stator winding to the first stator winding in response to an inductive coupling, and wherein the first fixed number of poles is not equal to the second fixed number of poles, wherein the variable number of poles is equal to the first fixed number of poles during a charging operation of the battery in response to the AC current, converting, by an inverter, the AC current received from the first stator winding to the DC current in response to an inverter control signal, and controlling, by an inverter controller, the inverter in response to the parameter of the AC current such that the battery is charged in response to the DC current.

In accordance with another aspect of the present disclosure, wherein the variable number of poles is not equal to the second fixed number of poles during a propulsion mode of the electric vehicle.

In accordance with another aspect of the present disclosure, wherein the AC current is coupled to a first winding of the first stator winding and is returned through a second winding of the first stator winding and a third winding of the first stator winding such that a first magnetic field generated in the first winding is cancelled by a second magnetic field generated in the second winding and a third magnetic field generated in the third winding.

In accordance with another aspect of the present disclosure, wherein during a propulsion mode of the electric vehicle the variable number of poles is not equal to the second fixed number of poles such that a voltage is not induced in the first stator winding.

In accordance with another aspect of the present disclosure, wherein the second stator winding is a high-turn winding and the rotor winding is a low-turn winding.

In accordance with another aspect of the present disclosure, wherein a pole number mismatch between the stator winding and the rotor winding caused the electric motor to lose synchronization, resulting in an elimination of torque and induced voltage of the electric motor.

In accordance with another aspect of the present disclosure, including a transformer for transforming the DC current to a DC voltage having an amplitude suitable for charging the battery.

In accordance with another aspect of the present disclosure, wherein the first fixed number of poles is double the second fixed number of poles.

In accordance with another aspect of the present disclosure, wherein the charging port is electrically coupled to the second stator winding by a first switch and to a diode pair return path by a second switch in a charging mode.

In accordance with another aspect of the present disclosure, an electric drive system for an electric vehicle including a charge port for receiving an AC current from an external power source, a sensor for detecting a phase of the AC current, an electric motor having a first stator winding having a variable number of poles including 16 poles and 8 poles, a second stator winding having 16 poles and a rotor winding having 8 poles, and wherein the first stator winding is configured to have 16 poles during a battery charging operation in response to the AC current and 8 poles during a propulsion mode of the electric vehicle, an inverter for converting the AC current received from the first stator winding to a DC current in response to an inverter control signal, and an inverter controller for controlling the inverter in response to the phase of the AC current to generate the DC current, a transformer for transforming the DC current to a DC voltage, and a battery, wherein the battery is charged in response to the DC voltage.

In accordance with another aspect of the present disclosure, wherein the second stator winding is omitted and the AC current is coupled to a first winding of the first stator winding and is returned through a second winding of the first stator winding and a third winding of the first stator winding such that a first magnetic field generated in the first winding is cancelled by a second magnetic field generated in the second winding and a third magnetic field generated in the third winding.

### BRIEF DESCRIPTION OF THE DRAWINGS

The exemplary embodiments will hereinafter be described in conjunction with the following drawing figures, wherein like numerals denote like elements, and wherein:

FIG. 1 shows a control system associated with a vehicle in accordance with various embodiments;

FIG. 2 shows an exemplary electric vehicle charging system employing a motor deactivation method with pole number mismatch in accordance with various embodiments;

FIG. 3 shows a cross section of an exemplary electric motor with a variable-pole electric motor with an auxiliary fixed-pole stator winding in accordance with various embodiments; and

FIG. 4 shows an exemplary electric vehicle charging system with a fixed-pole electric motor with a fixed-pole stator winding in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

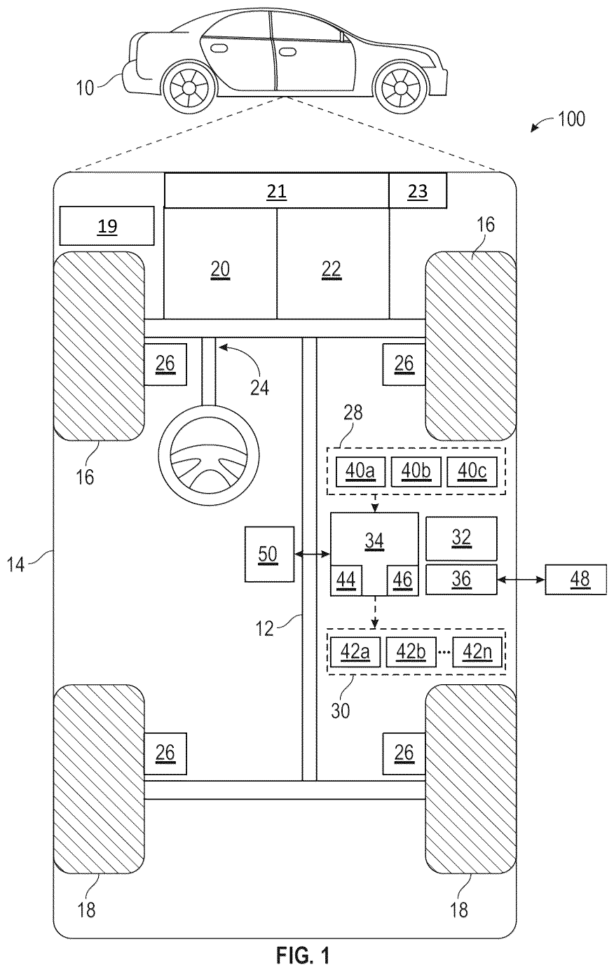

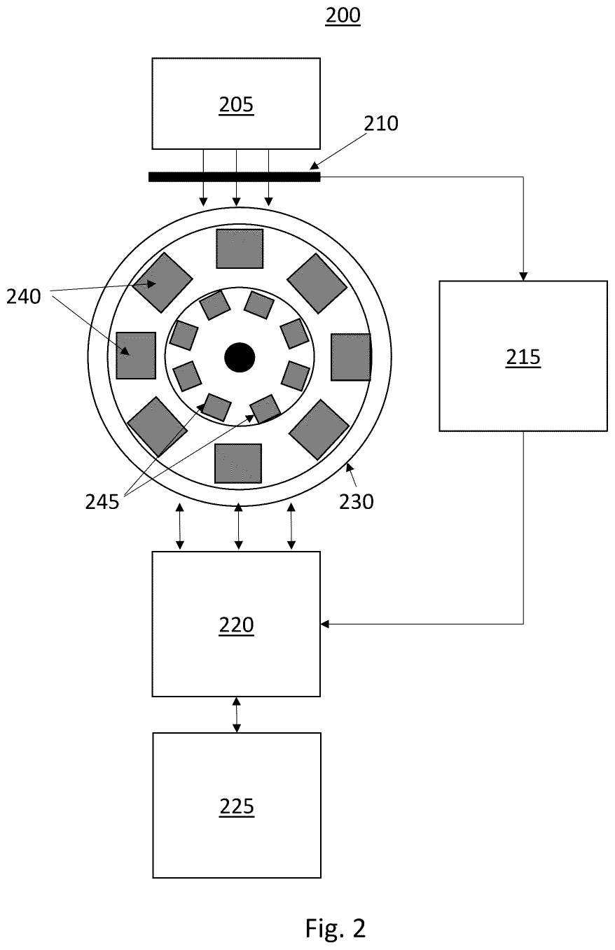

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., torque control) established by Reinforcement Learning (RL) which is or can be stored in a deep neural network (DNN) type model that controls operation in response to data from vehicle inputs, for example, as described in greater detail further below in connection with FIGS. 2-4.

In various exemplary embodiments, system 100 provides a process using an algorithm that controls torque and speed in a host vehicle's 10 embedded controller software of the system 100 allowing DNN to be used for a automated cruise control behavior prediction model. The system 100 enables learning of driver's preference for following distance for different vehicles such a target vehicle and to classify driver's preference based on driving scenarios; e.g., traffic signs, stop and go traffic, city driving, and the like. The system 100 uses a quadrature matrix to build a knowledge base for target vehicles following a performance preference by utilizing online and historical driver and environmental information.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, an electric machine such as a traction motor, a battery 21, an inverter 19 for converting direct current (DC) current from the battery to alternating current (AC) current to be supplied to the electric machine, and an on board charger (OBC) 23 for converting AC current from an external power source to a DC current to be used to charge the battery 21. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 1).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10, including the storing of data of a DNN that is established by the RL, used to predict a driver behavior for the vehicle control. In various embodiments, the data storage device 32 stores a machine learning model of a DNN and other data models established by the RL. The model established by the RL can take place for a DNN behavior prediction model or RL established model (See. FIG. 2, DNN prediction model or RL prediction model). In an exemplary embodiment, no separate training is required for the DNN rather, the DNN behavior prediction model (i.e., DNN prediction model) is implemented with a set of learned functions. In various embodiments, the neural network (i.e., DNN behavior prediction model) may be established by RL or trained by a supervised learning methodology by a remote system and communicated or provisioned in vehicle 10 (wirelessly and/or in a wired manner) and stored in the data storage device 32. The DNN behavior prediction model can also be trained via supervised or unsupervised learning based on input vehicle data of a host vehicle operations and/or sensed data about a host vehicles operating environment.

The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 implements the logic model established by reinforced learning (RL) or for the DNN based on the DNN behavior model that has been trained with a set of values, includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other, infrastructure, remote transportation systems, and/or user devices (described in more detail with regard to FIG. 2). In an exemplary embodiment, the communication system 36 is a wireless communication system configured to communicate via a wireless local area network (WLAN) using wireless network protocol or cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

Turning now to FIG. 2, an exemplary electric vehicle (EV) charging system 200 employing a motor deactivation method with pole number mismatch is shown in accordance with various embodiments. The exemplary EV charging system 200 can include an input 205 for receiving an alternating current (AC) current from an external source, such as a power grid, a sensor 210, an electric motor 230, an inverter 220, an inverter controller 215, and a battery 225.

A key factor in the appeal of EVs is their operational range. To enhance this range, manufacturers implement various energy-saving techniques, including weight reduction. One innovative approach involves leveraging the existing vehicle propulsion system for use in battery charging. By repurposing the vehicle's inverter 220 and inverter controller 215, which typically convert direct current (DC) battery power to AC power for the electric motor 230, the EV can be equipped with bidirectional charging capability. This enables the vehicle to draw AC power from an external source and convert it back into DC power to charge the battery 225. This eliminates the need for a separate onboard charger, resulting in a significant weight reduction and contributing to improved overall vehicle efficiency and range. To maximize the efficiency of power transfer between the external AC source and the vehicle's battery 225, it is desirable to mitigate any torque generation and any voltage generated through back-electromagnetic force within the electric motor 230 that may arise from current flow through its windings to ensure optimal energy exchange without inducing unnecessary mechanical stress on the motor.

In a charging mode, it is desirable to mismatch a number of rotor winding poles with a number of stator winding poles to avoid unwanted torque delivered to the rotor. For example, when directly connecting an electric motor 230 to an external AC source to couple an AC current to the inverter 220, employing a high-turn, high-inductance grid-side winding coupled with a low-turn winding and a shared pole number is advantageous for coupling AC current from the high-turn grid side winding to the low-turn winding.

However, during propulsion mode, this matched pole number between the stator windings can lead to significant back electromagnetic force (EMF) (up to 2.4 kV) in the high-turn winding due to the voltage ratio. To address this issue, pole number mismatch can be leveraged to deactivate the flux coupling between the high-turn stator winding and the low turn stator winding. By intentionally mismatching the pole numbers of the high turn grid side winding and the low turn stator winding, the machine loses synchronization, preventing torque generation and back-EMF induction. In some exemplary embodiments, to transition between propulsion and charging modes, pole-changing windings can be utilized. By maintaining a matching pole number between the low-turn stator winding and the rotor winding pole number during propulsion, the electric motor 230 generates torque as required. When charging operation is desired, the pole number between the low-turn stator winding and the rotor winding pole number is mismatched, balancing the electromagnetic forces applied from the low-turn stator winding on the rotor windings, thereby effectively deactivating the electric motor 230 and eliminating unwanted torque to the rotor.

In charging mode, the AC source input 205 is coupled to an external source of AC power, such as a local power grid or the like. In some exemplary embodiments, the external source can provide a three phase AC supply, although the currently described system can be utilized with a single phase AC supply. A sensor 210 can be used to detect the current, voltage and phase of each of the supplied AC currents. This sensor data can then be coupled to the inverter controller 215 for controlling the inverter 220 for converting the AC currents to a DC voltage to be used for charging the battery 225.

To avoid the unwanted generation of torque in the electric motor 230 while in charging mode, the electric motor 230 can be configured with a mismatched number of poles between the low-turn stator winding 240 and the rotor windings 245. The configuration of the pole mismatch can be achieved by a number of configuration variants including variable-pole stator with auxiliary fixed pole winding, fixed-pole stator with auxiliary variable-pole winding and fixed-pole stator with variable-pole rotor. For example, when an 8-pole rotor field induces a force in a 16-pole stator winding and the 16-pole stator winding induces a force in the 8-pole rotor winding, the forces within the stator winding oppose each other due to the mismatch in pole numbers. This cancellation effect results in a zero net torque of zero.

In propulsion mode, if the high-turn stator winding and the rotor windings have the same number of poles, an undesirable back-EMF induced voltage can be induced in the high-turn stator winding which is disconnected from the external AC power source. To avoid this induced voltage, it is desirable to mismatch the poles between the high turn stator winding and the low turn stator winding such that the number of poles in the low turn stator winding matches the number of poles in the rotor winding, and the number of poles in the high turn stator winding doesn't match the number of poles of the rotor winding and the low-turn stator winding. When magnetic fields with differing pole counts interact, they fail to synchronize. This lack of synchronization prevents generation of torque and back EMF.

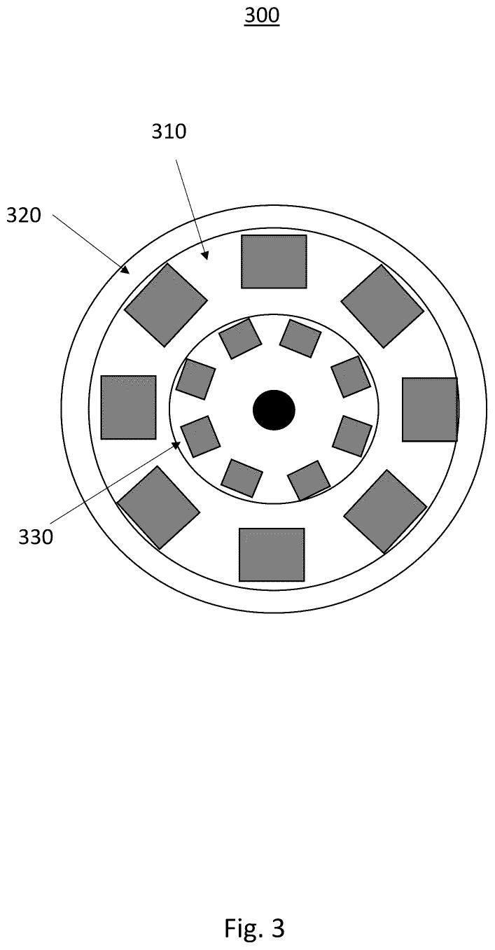

Turning now to FIG. 3 is illustrative of a cross section of an exemplary electric motor 300 with a variable-pole electric motor with an auxiliary fixed-pole stator winding 310 in accordance with various embodiments. In some exemplary embodiments, an auxiliary winding can be added to the electric motor in order to facilitate charging through the stator windings. In some exemplary embodiments, the rotor winding 330 can be an 16/8 pole winding, and the stator can include a 16 pole high turn winding 310 for coupling to the external AC source during charging and a 16/8 pole variable-pole low-turn winding 320. During propulsion mode, the rotor winding 330 is configured as an 8 pole winding and the 16/8 pole variable pole winding is configured as an 8 pole low turn winding to enable a magnetic field interaction between the stator and rotor windings to enable torque generation in the motor. The rotating magnetic field from the stator winding 320 interacts with the magnetic field created by the rotor winding 330. This interaction creates a force on the rotor, causing it to rotate. The direction of the force is such that it aligns the rotor's magnetic field with the stator's rotating magnetic field. This force, acting perpendicular to the rotor's axis of rotation, produces torque. In this configuration, the 16 pole, high turn winding 310 will not have a voltage induced on it as a result of the pole mismatch between the 16 pole high turn winding 310 and the 8 pole low turn stator winding 320 resulting in an elimination of the back-EMF induced on the high turn winding 310.

In charging mode, the 16 pole/8 variable pole, low turn winding 320 can be configured as a 16 pole winding, matching the number of poles of the high turn winding 310. The rotor winding 330 is also configured as a 16 pole winding. This facilitates the inductive coupling between the 16 pole stator windings and 16-pole rotor winding.

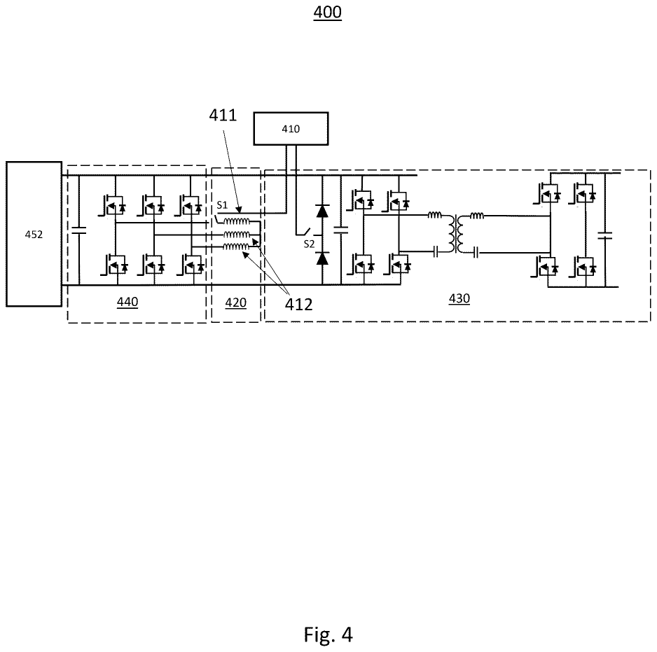

Turning now to FIG. 4 is illustrative of an exemplary EV charging system 400 with a fixed-pole electric motor with a fixed-pole stator winding in accordance with various embodiments. During propulsion mode, the fixed pole electric motor and the fixed pole stator will have a matching number of poles, such as 16 poles to accommodate efficient torque generation. However, to facilitate battery charging through the stator windings in an electric motor without torque generation, it is desirable to create a situation where a pole mismatch occurs between the stator and the rotor. To achieve this goal, a technique is performed wherein a single phase grid current from a single phase AC source 410 can be coupled to the stator windings and flow through a first stator winding 411 of a the three phase electric motor 420 with the current being returned through a second and third stator windings 412. The stator pole number is different from the rotor pole number. As a result, the motor produces zero or limited torque, regardless of the rotor's initial position.

During charging operation, the AC input 410 is coupled to the first stator winding 411 by a first switch S1. The currents from the stator windings 411, 412 are coupled to an inverter 440 for conversion from AC currents to DC currents. These DC currents can then couple to a DC-DC converter 430 for transformation to a DC value suitable for charging the EV battery 452. A switching circuit 450 can be configured to facilitate the coupling of the transformed DC voltage to the battery 452 and isolation of the battery 452 from the inverter 440 during charging mode and coupling the battery 452 to the inverter 440 and isolation from the DC-DC converter 430 during propulsion mode. The return path is provide by a diode pair and is coupled to the AC input 410 via a second switch S2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An electric drive system comprising:
a battery, wherein the battery is charged in response to a direct current (DC) current;
an input for receiving an alternating current (AC) current from an external power source;
a sensor for detecting a parameter of the AC current;
an electric motor having a first stator winding having a variable number of poles, a second stator winding having a first fixed number of poles and a rotor having a second fixed number of poles, wherein the variable number of poles selects a pole number that is equal to the first fixed number of poles and the second fixed number of poles during a battery charging operation;
an inverter for converting the AC current received from the first stator winding to the DC current in response to an inverter control signal; and
an inverter controller for controlling the inverter in response to the parameter of the AC current such that the battery is charged in response to the DC current.

2. The electric drive system of claim 1, wherein the variable number of poles is equal to the second fixed number of poles during a propulsion mode of an electric vehicle.

3. The electric drive system of claim 1, wherein during a propulsion mode of an electric vehicle the variable number of poles is not equal to the second fixed number of poles such that a voltage is not induced in a rotor winding.

4. The electric drive system of claim 1, wherein the first stator winding and the second stator winding may have different number of turns.

5. The electric drive system of claim 1, wherein a pole number mismatch between a rotor winding and the second stator winding caused the electric motor to lose synchronization, resulting in a elimination of torque or induced voltage of the electric motor.

6. The electric drive system of claim 1, further including a transformer for transforming the DC current to a DC voltage having an amplitude suitable for charging the battery.

7. The electric drive system of claim 1, wherein the sensor is configured to detect a phase of the AC current and wherein the inverter controller is configured to control the inverter in response to the phase of the AC current.

8. The electric drive system of claim 1, wherein the AC current is a three phase current and wherein the parameter is a phase difference between a first phase and a second phase of the three phase current.

9. The electric drive system of claim 1, wherein the input is electrically coupled to the electric motor by a first switch and to a diode pair return path by a second switch in a charging mode.

10. A method of controlling an electric drive system in an electric vehicle comprising:
charging a battery in response to a direct current (DC) current;
receiving, at a charging port, an alternating current (AC) current from an external power source;
detecting, by a sensor, a parameter of the AC current;
coupling the AC current to a second stator winding of an electric motor having a first stator winding having a variable number of poles, the second stator winding having a first fixed number of poles and a rotor winding having a second fixed number of poles, such that the AC current is coupled from the second stator winding to the first stator winding in response to an inductive coupling, and wherein the first fixed number of poles is not equal to the second fixed number of poles, wherein the variable number of poles is equal to the first fixed number of poles during a charging operation of the battery in response to the AC current;
converting, by an inverter, the AC current received from the first stator winding to the DC current in response to an inverter control signal; and
controlling, by an inverter controller, the inverter in response to the parameter of the AC current such that the battery is charged in response to the DC current.

11. The method of controlling the electric drive system for the electric vehicle of claim 10, wherein the variable number of poles is not equal to the second fixed number of poles during a propulsion mode of the electric vehicle.

12. The method of controlling the electric drive system for the electric vehicle of claim 10, wherein the AC current is coupled to a first winding of the first stator winding and is returned through a second winding of the first stator winding and a third winding of the first stator winding such that a first magnetic field generated in the first winding is cancelled by a second magnetic field generated in the second winding and a third magnetic field generated in the third winding.

13. The method of controlling the electric drive system for the electric vehicle of claim 10, wherein during a propulsion mode of the electric vehicle the variable number of poles is not equal to the second fixed number of poles such that a voltage is not induced in the first stator winding.

14. The method of controlling the electric drive system for the electric vehicle of claim 10, wherein the second stator winding is a high-turn winding and the rotor winding is a low-turn winding.

15. The method of controlling the electric drive system for the electric vehicle of claim 10, wherein a pole number mismatch between the first stator winding and the rotor winding caused the electric motor to lose synchronization, resulting in an elimination of torque and induced voltage of the electric motor.

16. The method of controlling the electric drive system for the electric vehicle of claim 10, further including a transformer for transforming the DC current to a DC voltage having an amplitude suitable for charging the battery.

17. The method of controlling the electric drive system for the electric vehicle of claim 10, wherein the first fixed number of poles is double the second fixed number of poles.

18. The method of controlling the electric drive system for the electric vehicle of claim 10, wherein the charging port is electrically coupled to the second stator winding by a first switch and to a diode pair return path by a second switch in a charging mode.

19. An electric drive system for an electric vehicle comprising:
a charge port for receiving an alternating current (AC) current from an external power source;
a sensor for detecting a phase of the AC current;
an electric motor having a first stator winding having a variable number of poles including sixteen poles and eight poles, a second stator winding having sixteen poles and a rotor winding having eight poles, and wherein the first stator winding is configured to have sixteen poles during a battery charging operation in response to the AC current and eight poles during a propulsion mode of the electric vehicle;
an inverter for converting the AC current received from the first stator winding to a direct current (DC) current in response to an inverter control signal;
an inverter controller for controlling the inverter in response to the phase of the AC current to generate the DC current;
a transformer for transforming the DC current to a DC voltage; and
a battery, wherein the battery is charged in response to the DC voltage.

20. The electric drive system for the electric vehicle of claim 19, wherein the second stator winding is omitted and the AC current is coupled to a first winding of the first stator winding and is returned through a second winding of the first stator winding and a third winding of the first stator winding such that a first magnetic field generated in the first winding is cancelled by a second magnetic field generated in the second winding and a third magnetic field generated in the third winding.
